(19) United States
(12) Patent Application Publication
(10) Pub. No.: US 2006/0236733 A1
(43) Pub. Date: Oct. 26, 2006

(54) High-security flat key and lock therefor

(75) Inventor: Baumhauer Walter, Vienna (AT)

Correspondence Address: THE FIRM OF KARL F ROSS, 5676 RIVERDALE AVENUE, PO BOX 900, RIVERDALE (BRONX), NY, 10471-0900, US

(73) Assignee: EVVA-Werk Spezialerzeugung von Zylinder-und Sicherheitsschlossern Gesellschaft m.b.H. & Co. KG

(21) Appl. No.: 11/402,375

(22) Filed: Apr. 11, 2006

(30) Foreign Application Priority Data
Apr. 12, 2005 (AT) A614/2005

(51) Int. Cl. E05B 29/08

(52) U.S. Cl. 70/495; 70/409

(57) ABSTRACT

A flat key has a blade formed with a pair of opposite edges, with a pair of opposite faces between the edges, and with an outer-end tip. The blade further is formed with a pair of relatively shallow, outwardly open, and generally parallel but spaced grooves formed in at least one of the faces and each extending generally longitudinally in a nonstraight path through a plurality of control points from the tip. Each of these shallow grooves has a greater transverse width outward toward the tip from one of its control points than inward from the one control point. A relatively deep and laterally open groove is formed in the one face mainly between the shallow grooves and extends generally longitudinally in a nonstraight path from the tip generally nonparallel to the shallow grooves.

### FIELD OF THE INVENTION

The present invention relates to a flat key. More particularly this invention concerns a lock usable with a special high-security flat key.

### BACKGROUND OF THE INVENTION

A standard flat key, as opposed to an axially bitted tubular key, has an elongated blade formed along one or both edges with bitting that coacts with tumblers carried in the plug of the lock for the key. In a standard system with seven bits each of which can be at four or five different levels, the number of combinations available is large but by no means impossible to discover by random action. In addition such a lock frequently can be forced relatively easily as the physical strength of a small number of slim tumblers, which are all that block rotation of the plug in the cylinder, is small.

In commonly owned U.S. Pat. No. 4,977,767 the flat key has a blade formed with a pair of opposite edges, with a pair of opposite faces between the edges, and with an outer-end tip. In addition this blade is formed with bitting along at least one of its edges, with a pair of relatively shallow, outwardly open, and generally parallel but spaced grooves formed in at least one of the faces extending generally longitudinally in a nonstraight path from the tip, and with a relatively deep and outwardly open groove formed in the one face and extending generally longitudinally in a nonstraight path from the tip generally nonparallel to the shallow grooves. The deep groove is between the shallow grooves and the shallow grooves have inner flanks separated by a spacing that is greater than the width of the deep groove. Furthermore the grooves flare parallel to the surface at and toward the tip.

The key in this patent has grooves that have control positions at which they extend substantially parallel to the blade and are inclined to the blade between the control positions. They can extend as straight-section zigzags or as more smoothly curved undulations. In fact each of the grooves has a plurality of such control positions and the control positions of the shallow grooves are transversely aligned and staggered relative to the control positions of the deep groove. The lock for this key has a relatively stationary lock housing, a lock cylinder rotatable in the housing about an axis and formed with an axially outwardly open flat passage shaped to snugly receive the key blade, a first slide displaceable in the cylinder generally secantally of the axis and parallel to the one face of a key in the passage and provided with a formation engageable generally radially of the axis in the deep groove, and a second slide displaceable in the cylinder generally secantally of the axis and parallel to the one face of a key in the passage and provided with a formation engageable generally radially of the axis in the shallow grooves. Thus the slides are shifted secantally on insertion of the key by interengagement of the formations and the respective grooves. A lock element is displaceable in only one predetermined position of the slides between a position blocking rotation of the cylinder in the housing and a position permitting such rotation.

### OBJECTS OF THE INVENTION

It is therefore an object of the present invention to provide an improved key and lock of the above-described general type.

Another object is the provision of such an improved key and lock of the above-described general type that overcomes the above-given disadvantages, in particular that offers a higher level of security than the described lock.

### SUMMARY OF THE INVENTION

A flat key according to the invention has a blade formed with a pair of opposite edges, with a pair of opposite faces between the edges, and with an outer-end tip. The blade further is formed with a pair of relatively shallow, outwardly open, and generally parallel but spaced grooves formed in at least one of the faces and each extending generally longitudinally in a nonstraight path through a plurality of control points from the tip. Each of these shallow grooves has a greater transverse width outward toward the tip from one of its control points than inward from the one control point. A relatively deep and outwardly open groove is formed in the one face mainly between the shallow grooves and extends generally longitudinally in a nonstraight path from the tip generally nonparallel to the shallow grooves.

This key is intended for use in a lock having a relatively stationary lock housing and a lock cylinder rotatable in the housing about an axis and formed with an axially outwardly open flat passage shaped to snugly receive the key blade. A first slide is displaceable in the cylinder generally secantally of the axis and parallel to the one face of a key in the passage and has a formation engageable generally radially of the axis in the deep groove. A second slide is displaceable in the cylinder generally secantally of the axis and parallel to the one face of a key in the passage and has a pair of narrow formations engageable generally radially of the axis in the shallow grooves and of generally the same transverse width as the shallow grooves. Normally there are a plurality of such second slides. In accordance with the invention a third slide is displaceable in the cylinder generally secantally of the axis and parallel to the one face of a key in the passage and has a pair of wide formations engageable generally radially of the axis in the shallow grooves and of generally the greater transverse width of the shallow grooves at the outermost points. The slides can shift secantally on insertion of the key by interengagement of the formations and the respective grooves when, of course, these grooves have their control points positioned to align with the respective formations. A lock element is displaceable in only one predetermined position of the slides between a position blocking rotation of the cylinder in the housing and a position permitting such rotation.

Thus with this system the third slide with the wide formations cannot fit in a key with the prior-art narrow grooves, making it impossible to operate a lock according to the invention with a prior-art key. Conversely a key for the system of this invention, if inserted in a prior-art lock will not transversely position the third slide accurately, making it impossible to operate a prior-art lock with the newer key of this invention.

According to the invention the one face is formed with a nonstraight ridge extending between and defining inner flanks of the shallow grooves. The ridge is of a predetermined identical effective transverse width between the points of each pair of points. Thus at the outermost control points the outer flanks of the shallow grooves flare outward. In this manner the formations or pins of the slides can ride along the shallow grooves, but only the wide formations or pins of the third slide will fit properly with the outer control points.

In accordance with the invention the outer control points are offset by half or some other fraction of the standard offset of the control points, making operation of the lock according to this invention impossible even with a somewhat reworked old-style key.

According to another feature of the invention the deep groove crosses the ridge only between the control points of the shallow grooves so that the ridge is always present between the control points of the shallow grooves. This ensures that the second slides do not get misaligned by catching in the deep groove.

The key according to the invention further is formed along at least one of its edges with standard bitting. This makes the lock extremely secure, as not only are there tumblers that shift in the plane of the key blade like in a standard lock, but there are also the control slides.

### BRIEF DESCRIPTION OF THE DRAWING

The above and other objects, features, and advantages will become more readily apparent from the following description, reference being made to the accompanying drawing in which:

FIG. 1 is a side view of a key blade according to the invention;

FIG. 2 is an end/sectional view of a part of a lock, a key according to the invention, and a first slide;

FIG. 3 is a view like FIG. 3, but showing a prior-art key;

FIGS. 4 and 5 are views like respective FIGS. 2 and 3 but showing further elements of the lock;

FIGS. 6, 7, and 8 are views of the first, second, and third slides in accordance with the invention.

### SPECIFIC DESCRIPTION

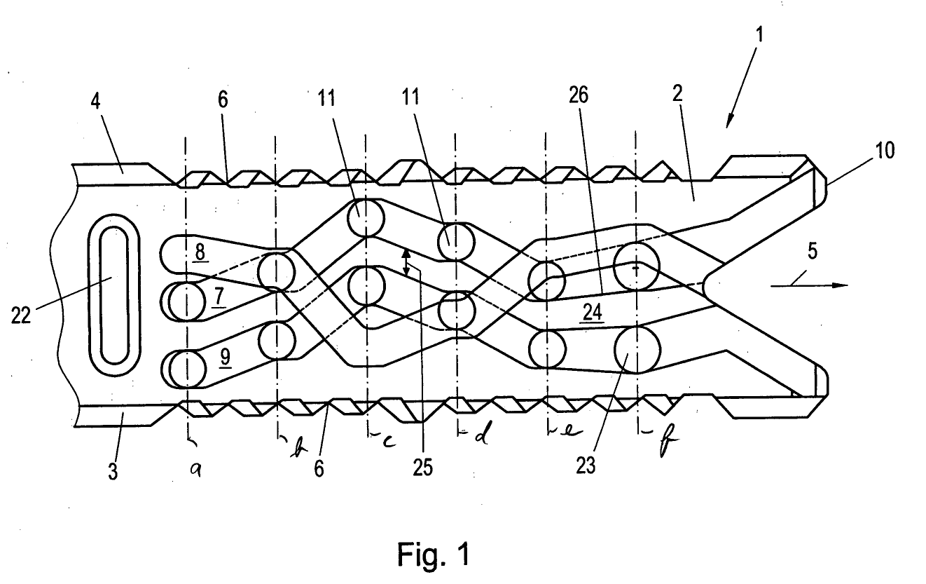

As seen in FIG. 1 a flat key 1 according to this invention has a flat blade 2 formed with a serrated or bitted front and rear edges 3 and 4 both extending parallel to a longitudinal direction 5 along which the key 1 is inserted into a lock described below. The edges 3 and 4 have bits 6 that cooperate with standard tumblers also described below. A recess 22 is milled in the inner end of the blade 2 that has an outer-end tip 10.

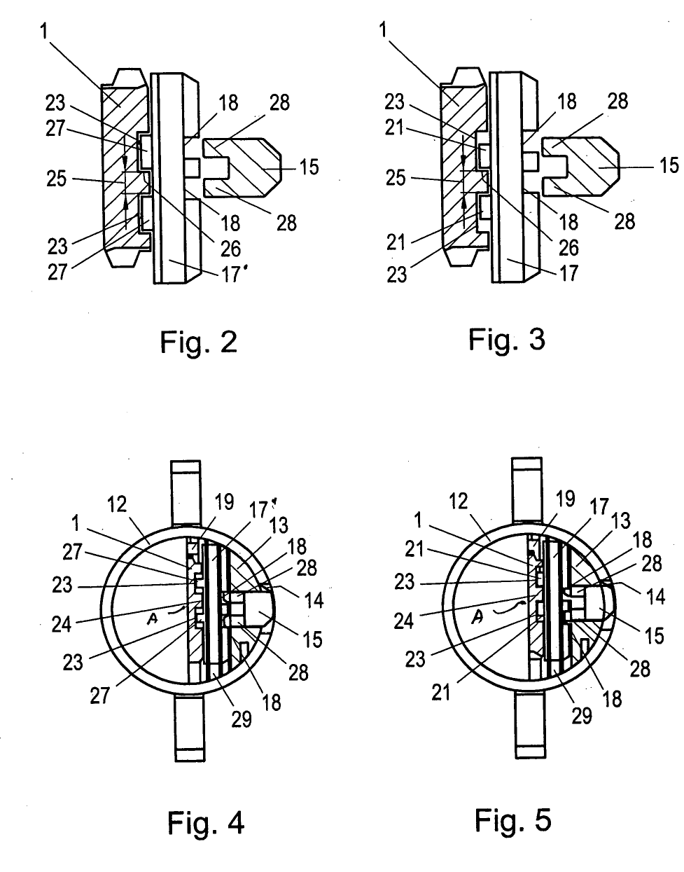

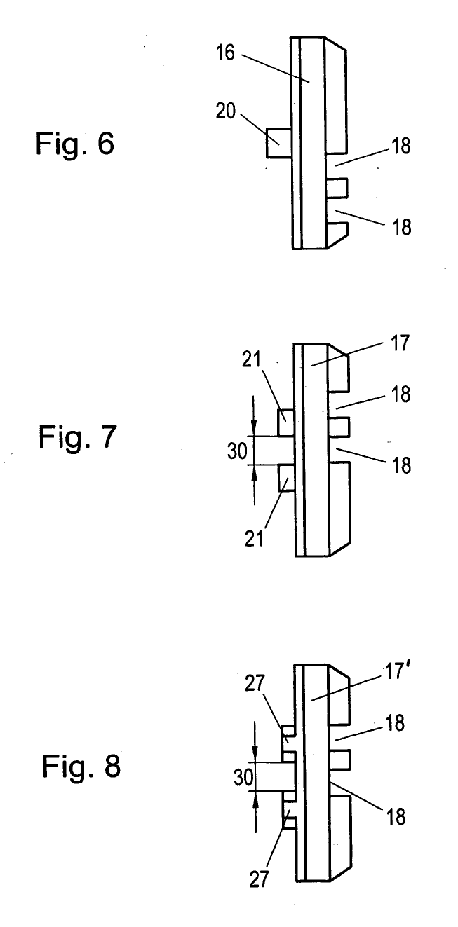

According to this invention at least one face of the blade 2 is formed with three generally longitudinally extending and laterally open nonstraight grooves 7, 8, and 9. The two grooves 7 and 9 are of substantially the same width and extend generally parallel to each other. These outer grooves 7 and 9 are relatively shallow (see FIGS. 2-5). The groove 8 is substantially deeper than the grooves 7 and 9 and does not extend parallel to either of these grooves 7 and 9 over any significant portion of its length. In addition the groove 8 crosses or at least partially overlaps each of these grooves 7 and 9 at several locations. In practice both faces of the blade 2 and both edges can be identically formed so that the key 1 can be inserted in a lock without having to worry which side is up.

The grooves 7 and 9 are intended to work with first and second slides 17 and 17′ (see FIGS. 2-5, 7, and 8) that are each formed on an inner face with a pair of pegs or formations 21 or 27 of cylindrical shape spaced apart by a distance 30. The formations 21 are of relatively small diameter and the formations 27 are of substantially larger diameter. In addition (see FIG. 7) one or more slides 16 have formations 20 that work with the deep groove 8. In practice the slide(s) 16 can be on one face of the blade 2 and the slides 17 and 17′ on the opposite face.

The grooves 7, 8, and 9 are inflected at longitudinally uniformly spaced levels indicated at a, b, c, d, e, and f in FIG. 1. The shallow grooves 7 and 9 are of uniform transverse width inward (to the left in FIG. 1) of the outermost level f and form inflection or control points 11. At the level f they are somewhat wider and form control points 23, and outward of these control points 23 these grooves 7 and 9 are of this greater width that is at least equal to the diameters of the pegs 27. There is therefore a ridge 24 extending along the key blade 2 and defining the inner flanks 26 of the two grooves 7 and 9. This ridge 24 is of uniform width 25 equal generally to the spacing 30 at the control points 11 and 23, although it may be slightly thinner therebetween. As a result the transverse spacing of the control points 11 at the levels a-e is identical, and at the control points 23 the inner flanks 26 of the grooves 8 and 9 are at the spacing 25, although the outer flanks are here more widely spaced than at the levels a-e.

As seen in FIGS. 4 and 5 the lock itself has a normally stationary housing sleeve 12 containing a cylinder or plug 13 centered on and rotatable in the sleeve 12 about an axis A. The. housing 12 has a cylindrical inner wall centered on the axis A and formed with an axially extending and radially inwardly opening part-cylindrical groove. The housing 12 holds standard split tumblers 19 that coact with the bitting 6 in standard manner.

The plug 13 itself is provided with a radially displaceable locking element 15 formed as an axially elongated bar having a rounded outer end engageable in the groove 14. A spring urges the locking bar 15 radially outward. The locking bar 15 is formed with a plurality of radially inwardly projecting formations or pegs 28 (see also FIGS. 2 and 3) engageable in seats 18 formed in the slides 17 and 17′ slidable tangentially of the axis A in respective tangential passages formed in the plug 13.

FIG. 3 shows a situation where the inventive key 1 is inserted into an old-style lock according to state of the art with slides 17 with narrow pins 21. The narrow pins 21 are guided across the inside flanks 26 of the web 24. Due to this guidance it is avoided that the slide 17 can move freely in the broadened control grooves 7, 9. Furthermore, the web 24 on the control site 23 for broad pins 27 is formed in a way that the narrow pins 21 are guided displaced by half a control step. A control step is the distance between two adjacent possible control levels of the pins 21 on a particular control level, in this system there are normally around 8 control steps. Due to the fact that the broad pins 27 are displaced by half a control step relative to the narrow pins 21, the narrow pins 21 in the control points 23 for wide pins 27 are displaced and the lock cannot be opened.

On the other hand, a flat key 1 that does not have its grooves 7 and 9 sided at the control points site 23 could not be entirely inserted into a lock according to the invention.

FIGS. 4 and 5 show equivalent arrangements to the FIGS. 2 and 3 in a cross-section of an invented lock. In these views, only one half of the key and the corresponding lock are shown. The key 1 is entirely inserted into the key channel 19. When inserting the key, the slide 17 is moved upwards and downwards due to the guidance of the guiding grooves 7, 9 in a passage 29 in the cylinder core 13. In the extreme position of the key, the bolts 27 of the slide 17 are in the dedicated control site 23. If now, as pointed out in the case shown in FIG. 4, the cylinder core 13 is turned in the body 12 of the lock, the locking element 15 is moved out of the stop groove 14, located in body 12, whereby the appendages 28 are received by the clearances 18 and thus, the lock is freed.

There is one slide 17 for each level a-e and one slide 17′ for the level f. The slides 17 and 17′ are thus axially equispaced at the levels a-e of FIG. 1. The slides 17 at the locations each have two short cylindrical pins 37 intended to engage in the outer grooves 7 and 9 and of the same diameter as the inner width of these grooves. The slides 30 which are provided at the locations b″, d″, and f″ each only have one such cylindrical pin 35 which engages through the respective slot 36 with the middle groove 8, these pins 35 being-longer than the pins 37 to fit complementary in the deeper groove 8.

In the lock shown in FIG. 5, a slide 17 is located with narrow pins 21 on the control point 23 of the flat key 1. Due to the guidance across the ridge 24, the slide 17 is misplaced by half a control step so that the projections 28 cannot be received in the seats 18, the locking element 15 remains in the stop groove 14 of the body 13, and the lock is thus not freed.

The width 25 of the ridge 24 and spacing 30 between the bolts 21 or 27 are generally the same, but can change depending on the arrangement of the angles of ridge 24. The width 25 of the web 24 at the control points 11 and 23 and spacing 30 remain unchanged, even though the width of the web 24, measured perpendicularly on the web faces 26, has to vary (see FIG. 1) between the control points 11 and 23.

I claim:

1. A flat key having a blade formed with a pair of opposite edges, with a pair of opposite faces between the edges, and with an outer-end tip, the blade further being formed with:
a pair of relatively shallow, outwardly open, and generally parallel but spaced grooves formed in at least one of the faces and each extending generally longitudinally in a nonstraight path through a plurality of control points from the tip, each of the shallow grooves having a greater transverse width outward toward the tip from one of its control points than inward from the one control point; and
a relatively deep and outwardly open groove formed in the one face mainly between the shallow grooves and extending generally longitudinally in a nonstraight path from the tip generally nonparallel to the shallow grooves.

2. The key defined in claim 1 wherein one face is formed with a nonstraight ridge extending between and defining inner flanks of the shallow grooves, the ridge being of a predetermined identical transverse width between the points of each pair of points.

3. The key defined in claim 1 wherein the deep groove crosses the ridge only between the control points of the shallow grooves, whereby the ridge is always present between the control points of the shallow grooves.

4. The key defined in claim 1 wherein the grooves all flare parallel to the one face at and toward the tip.

5. The key-defined in claim 1 wherein the one control point is that control point closest to the tip.

6. In combination with a flat key having a blade formed with a pair of opposite edges, with a pair of opposite faces between the edges, and with an outer-end tip, the blade further being formed with:
bitting along at least one of the edges;
a pair of relatively shallow, outwardly open, and generally parallel but spaced grooves formed in at least one of the faces and each extending generally longitudinally in a nonstraight path through a plurality of control points from the tip, each of the shallow grooves having a greater transverse width outward toward the tip from one of its control points than inward from the one control point; and
a relatively deep and outwardly open groove formed in the one face and extending generally longitudinally in a nonstraight path from the tip generally nonparallel to the shallow grooves;
a lock comprising:
a relatively stationary lock housing;
a lock cylinder rotatable in the housing about an axis and formed with an axially outwardly open flat passage shaped to snugly receive the key blade;
a first slide displaceable in the cylinder generally secantally of the axis and parallel to the one face of a key in the passage and provided with a formation engageable generally radially of the axis in the deep groove;
a second slide displaceable in the cylinder generally secantally of the axis and parallel to the one face of a key in the passage and provided with a pair of narrow formations engageable generally radially of the axis in the shallow grooves and of generally the same transverse width as the shallow grooves;
a third slide displaceable in the cylinder generally secantally of the axis and parallel to the one face of a key in the passage and provided with a pair of wide formations engageable generally radially of the axis in the shallow grooves and of generally the greater transverse width of the shallow grooves at the outermost points, whereby the slides are shifted secantally on insertion of the key by interengagement of the formations and the respective grooves; and
a lock element displaceable in only one predetermined position of the slides between a position blocking rotation of the cylinder in the housing and a position permitting such rotation.

7. The combination defined in claim 6 wherein the narrow formations of the second slide are fixedly spaced transversely of the key blade relative to each other.

8. The combination defined in claim 6 wherein the deep groove is between the shallow grooves.

9. The key defined in claim 8 wherein the shallow grooves have inner flanks separated by a spacing and the deep groove has a width smaller than the spacing.

10. The key defined in claim 6 wherein the grooves flare parallel to the surface at and toward the tip.

11. The key defined in claim 6 wherein the deep groove intersects at least one of the shallow grooves.
